(19) United States
(12) Patent Application Publication
(10) Pub. No.: US 2010/0078080 A1
(43) Pub. Date: Apr. 1, 2010

(54) Shutoff device, implemented as a ball cock, for use in a line for media

(75) Inventor: Joerg Vehmeier, Lage (DE)

Correspondence Address: COLLARD & ROE, P.C., 1077 NORTHERN BOULEVARD, ROSLYN, NY, 11576, US

(73) Assignee: PAW GmbH & Co. KG

(21) Appl. No.: 12/586,679

(22) Filed: Sep. 25, 2009

(30) Foreign Application Priority Data
Sep. 27, 2008 (DE) 20 2008 012 913.3

(51) Int. Cl. F16K 15/00

(52) U.S. Cl. 137/455

(57) ABSTRACT

A shutoff device is implemented as a ball cock for insertion into a line for media, and has a housing insertable into the course of the line, a shutoff ball rotatably disposed in the housing, and a pivot drive for the shutoff ball. The pivot drive is removably connected to the housing. The shutoff ball has a passage in an area facing toward the pivot drive, and a chamber extends through the passage from the pivot drive into the interior of the shutoff ball. A sensor embedded in the chamber.

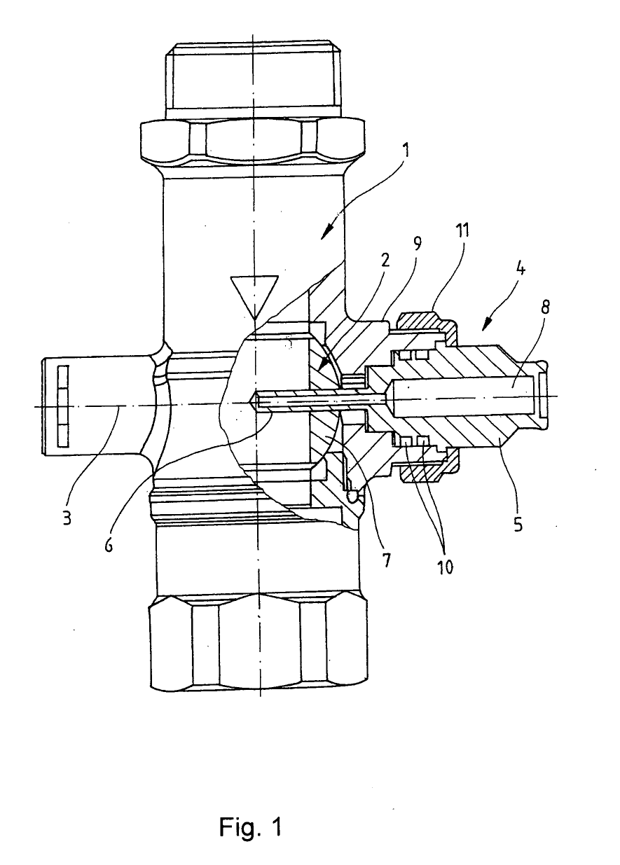

### CROSS REFERENCE TO RELATED APPLICATIONS

Applicants claim priority under 35 U.S.C. §119 of German Application No. 20 2008 012 913.3 filed Sep. 27, 2008.

### BACKGROUND OF THE INVENTION

1. Field of the Invention

The invention relates to a shutoff device, implemented as a ball cock, for use in a line for media. The shutoff device has a housing that is insertable into the course of the line, in which a shutoff ball is received so it is rotatable and which carries a pivot drive for the shutoff ball.

2. The Prior Art

Shutoff devices implemented as ball cocks are known as simple closure mechanisms for lines. Their housing is inserted into the course of a line. A drilled-through shutoff ball is received in the housing, which releases a line cross-section or closes the line cross-section by pivoting around approximately 90°. Media in the line may be gases, liquids, or also solid bulk materials.

In many processes, it is necessary to obtain information about physical properties of the media located in a line, for example, about the temperature or pressure conditions. Therefore, situating a sensor in the area of the housing of a ball cock has already been proposed. In a known shutoff device, a passage is introduced into the housing on a side of the housing opposite to the pivot drive, through which a sensor may protrude into the interior of the housing. Although a temperature measurement, for example, may be performed in this way, a further work step is necessary during the manufacturing of the housing due to the additional provision of the housing with a further passage. In additional, a potential leak point is provided by this further passage.

### SUMMARY OF THE INVENTION

It is therefore an object of the invention to provide a shutoff device which is distinguished by a simple apparatus construction and which integrates a sensor in a simple way.

This object is achieved according to the invention in that the shutoff ball has a passage in an area facing toward the pivot drive and, starting from the pivot drive, a chamber for receiving a sensor extends through the passage into the interior of the shutoff ball. The pivot drive is removably connected to the housing, and the sensor is embedded in the chamber.

In the shutoff device according to the invention, a further passage for situating a sensor is not necessary. The sensor is led starting from the pivot drive into the interior of the shutoff ball, i.e., the passage in the housing of the ball cock provided for the pivot drive in any case is also used for the sensor. To situate the sensor in the interior of the shutoff ball, the passage is provided in the wall of the shutoff ball through which the chamber protrudes. The sensor is situated in the chamber, namely in the area protruding into the interior of the shutoff ball, and embedded in this chamber. The sensor is situated fixed by the embedding, and the sensor may also form a section of the chamber outside wall. The pivot drive, with its chamber becomes a sensor housing which contacts the measured media. Because of the property that the pivot drive is removably connected to the housing, it is additionally possible to replace the pivot drive.

According to a first embodiment, the pivot drive is implemented as a hollow spindle, and the cavity of the spindle extends up into the chamber. The hollow spindle and chamber are preferably implemented integrally, and they have a shared cavity. The sensor may be situated in this cavity. If the hollow spindle is removed from the shutoff device, the chamber having the sensor is also removed. Various sensors may thus be introduced into the same ball cock in a simple way.

The chamber is preferably implemented as a hollow profile, and it may have a pin shape. If it is situated in the rotational axis of the ball cock, the rotation of the ball cock is not obstructed by the chamber.

The sensor is a temperature sensor, for example. In the chamber protruding into the interior of the shutoff ball, it approaches close to the medium which is conducted through the line. The sensor may also be a pressure sensor; at least one passage is then provided in the wall of the chamber, so that the medium to be measured may also act on the pressure sensor.

The hollow spindle is inserted into the housing of the shutoff device with seals. It may be secured using a union nut, after the nut is removed. The hollow spindle may be easily withdrawn from the housing of the shutoff device. The sensor is thus replaceable, without leaving the pipeline network. When the ball cock is shut off, the cavity of the ball is still filled with medium, but is additionally sealed, however. After the removal of the spindle union nut, only the medium contained in the ball cock escapes when the spindle is withdrawn. In addition, the line is sealed.

A connection line may be led up to the sensor for the sensor and also embedded in the interior of the chamber. Plug connections for electrical lines may also be provided in the area of the hollow spindle, however.

### BRIEF DESCRIPTION OF THE DRAWINGS

Other objects and features of the present invention will become apparent from the following detailed description considered in connection with the accompanying drawing. It is to be understood, however, that the drawing is designed as an illustration only and not as a definition of the limits of the invention.

An exemplary embodiment of the shutoff device according to the invention is shown in a partially sectional side view in the single FIGURE of the drawing.

### DETAILED DESCRIPTION OF THE PREFERRED EMBODIMENT

The shutoff device is implemented as a ball cock, having a housing 1. Housing 1 may be inserted into the course of a line for media. A drilled-through shutoff ball 2, which is rotatable around an axis 3, is situated in the interior of housing 1.

A pivot drive 4 is associated with the shutoff ball 2. Pivot drive 4 is implemented as a hollow spindle 5, which has components connected rotationally fixed to shutoff ball 2, which may transmit a drive force for pivoting shutoff ball 2 thereon.

A chamber 6 leads into the interior of the shutoff ball 2 starting from the hollow spindle 5. A passage is situated in wall 7 of shutoff ball 2 facing toward pivot drive 4, through which chamber 6 protrudes into the interior of shutoff ball 2. Chamber 6 is implemented as a hollow profile, and has a pin shape. A cavity 8 is situated in the interior of chamber 6 and in the interior of hollow spindle 5, which may be used to situate a sensor (not shown). The sensor is led up into chamber 6 starting from hollow spindle 5 and embedded therein.

Hollow spindle 5 is removable from a socket 9 of housing 1. It is received via sealing rings 10 in socket 9 and fixed using a union nut 11. After union nut 11 is removed, hollow spindle 5 is removable with chamber 6 from socket 9 of housing 1 and replaceable with another hollow spindle 5 optionally having another sensor.

No passage is to be provided in housing 1 on the side opposite to hollow spindle 5.

Accordingly, while only a few embodiments of the present invention have been shown and described, it is obvious that many changes and modifications may be made thereunto without departing from the spirit and scope of the invention.

What is claimed is:

1. A shutoff device, which is implemented as a ball cock, for insertion into a line for media, comprising:
a housing insertable into the course of the line;
a shutoff ball rotatably disposed in the housing; and
a pivot drive for the shutoff ball, said pivot drive being removably connected to the housing,
wherein the shutoff ball has a passage in an area facing toward the pivot drive, wherein a chamber extends through the passage from the pivot drive into the interior of the shutoff ball, and further comprising a sensor embedded in the chamber.

2. The shutoff device according to claim 1, wherein the pivot drive is implemented as a hollow spindle having a cavity that extends into the chamber.

3. The shutoff device according to claim 1, wherein the chamber is implemented as a hollow profile.

4. The shutoff device according to claim 1, wherein the sensor is a temperature sensor.

5. The shutoff device according to claim 1, wherein at least one passage is situated in a wall of the chamber, and the sensor is a pressure sensor.
